(19) United States
(12) Patent Application Publication
(10) Pub. No.: US 2004/0221478 A1
(43) Pub. Date: Nov. 11, 2004

(54) Structure for shielding exposed part of core wire of terminal block in clothes dryer

(75) Inventors: Soon Jo Lee, Changwon-si (KR); Ju Han Yoon, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 10/663,995

(22) Filed: Sep. 17, 2003

(30) Foreign Application Priority Data
Sep. 18, 2002 (KR) P 2002-00056977

(51) Int. Cl. F26B 11/02

(52) U.S. Cl. 34/603

(57) ABSTRACT

A structure for shielding an exposed part of core wire of a terminal block in a clothes dryer is disclosed. The structure of the terminal block in the clothes dryer is improved to cover a connector connecting the terminal with the core wire for preventing accidents caused by contacting the exposed part of core wire of the terminal block during service, the clothes dryer including a base 1 forming a floor, a front cabinet 2 forming a front of the clothes dryer, a side cabinet 3 forming a side of the clothes dryer, a back cover 4 forming a back side of the clothes dryer, a top cover 5 provided on a top surface of the front cabinet 2, the side cabinet 3 and the back cover 4, a control panel 6 provided on a rear of the top cover 5, and a terminal block provided on an inside of the control panel 6, and having a wall 800 in upper and lower front surfaces thereof.

### CROSS-REFERENCE TO RELATED APPLICATIONS

This application claims the benefit of Korean Application No. P2002-56977, filed on Sep. 18, 2002, which is hereby incorporated by reference as if fully set forth herein.

### BACKGROUND OF THE INVENTION

1. Field of the Invention

The present invention relates to a clothes dryer, and more particularly, to a structure for shielding exposed part of core wire of terminal block in clothes dryer.

2. Discussion of the Related Art

In general, a clothes dryer is an apparatus for drying a wet article (for example, clothes) and is composed as follows. FIG. 1 is a bird-eye view illustrating an external view of a clothes dryer. Body B of the clothes dryer includes a base 1 forming a floor, a front cabinet 2 forming a front of the clothes dryer, a side cabinet 3 forming a side of the clothes dryer, a back cover 4 forming a back side of the clothes dryer, a top cover 5 forming a top of the clothes dryer, and a control panel 6 provided on a rear of the top cover 5.

The front cabinet 2 forming a structural element of the body of the conventional clothes dryer includes an opening for putting the respective article in and out thereof. A drum for drying (not illustrated) is rotatably provided in the body of the clothes dryer for receiving driving force and rotating. A door is also provided to selectively open and close the opening on the front cabinet 2.

A hot-air supply channel and a hot-air discharge channel are connected to the drying drum. A heater (not illustrated) is provided on the hot-air supply channel for heating air flowed in from the exterior of the dryer and a fan (not illustrated) is provided on the hot-air discharge channel for blowing the air heated by the heater to an outside of the body B after drying clothes is finished.

Meanwhile, a terminal 8 is provided on an inside of the control panel 6 as a means of supplying power. A power code wire 9a is connected to a terminal at a lower part of the terminal block 8 for supplying power from outside and an inner wire 9b to a terminal at an upper part of the terminal block 8 for supplying power to each part in the dryer.

An operation of the clothes dryer will be described as follows. First, the heater and a motor (not illustrated) runs if the drying administration is carried out. According to an operation of a ventilating fan, outside air flowed to an inside of the body B through a sucking side of the hot-air supplying channel is changed into hot-air passing through the heater, and flowed to an inside of the drying drum through the hot-air supplying channel.

To this end, the hot-air repeats the steps of being flowed to the inside of the drying drum by the sucking force of the discharging fan, evaporating moisture of the wet article and being discharged to the outside of the body B through a discharging side of the hot-air discharge channel. At this time, the drying drum receives operating force of the motor and slowly rotates. The wet article is dried in the process.

However, the conventional clothes dryer has problems as follows. In the structure of the terminal block 8 in the conventional clothes dryer, an exposed part of core wire connecting each wire with the terminal is exposed. Therefore, it is concerned that an accident caused by touching the exposed part of core wire 10 is generated while a worker fixes or changes parts and there is a safety problem.

### SUMMARY OF THE INVENTION

Accordingly, the present invention is directed to a structure for shielding an exposed part of core wire of a terminal block in a clothes dryer that substantially obviates one or more problems due to limitations and disadvantages of the related art.

An object of the present invention is to provide a structure for shielding an exposed part of core wire of terminal block in a clothes dryer to prevent an accident caused by touching the high voltage exposed part of core wire 10 by hands from being generated beforehand while workers fix or change parts.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a structure for shielding exposed part of core wire of terminal block having a shielding wall at upper and lower side of the front surface thereof in clothes dryer includes a base forming a floor, a front cabinet forming a front of the clothes dryer, a side cabinet forming a side of the clothes dryer, a back cover forming a back side of the clothes dryer, a top cover provided on a top surface of the front cabinet 2, the side cabinet 3 and the back cover 4, and a control panel provided on a rear of the top cover.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a bird-eye view illustrating an example of an exterior of a clothes dryer.

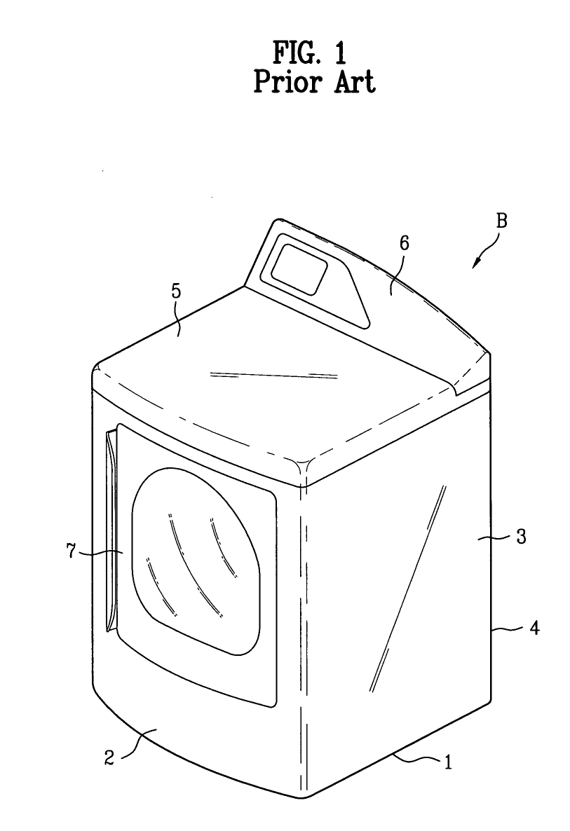

FIG. 2 is a cross-sectional view of a principle part of a related art and of a control panel of FIG. 1.

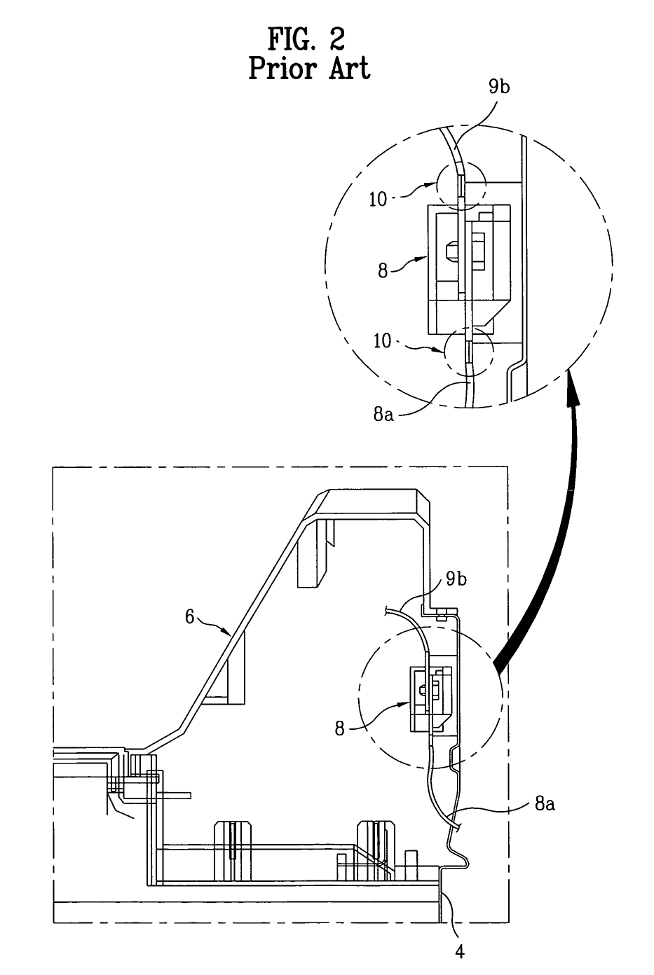

FIG. 3 is a cross-sectional view of a principle part of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

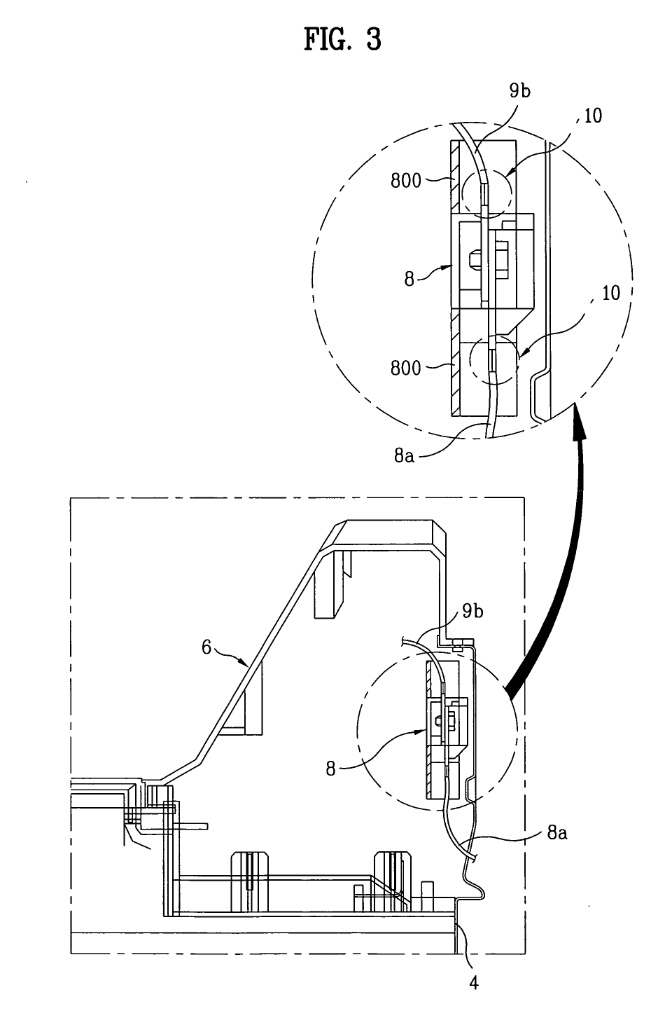

Hereinafter, a preferred embodiment of the present invention will be described referring to FIG. 3. FIG. 3 is a cross-sectional view of a principle part of the present invention including a base 1 forming a floor, a front cabinet 2 forming a front surface of the body B, a side cabinet 3 forming a side of the clothes dryer, a back cover 4 forming a back side of the body B, a top cover 5 provided on a top surface of the front cabinet 2, the side cabinet 3 and the back cover 4, and a control panel 6 provided on a rear of the top cover, and a terminal block 8 provided between an inside of the control panel 6, the terminal block 8 having a wall 800 for shielding exposed part of core wire.

Mechanism of the present invention composed as aforementioned is as follows. A wall for shielding exposed part of core wire of the terminal block is provided in upper and lower front surfaces of the terminal block 8 of the present invention so as to prevent workers from contacting the exposed part of core wire of the terminal block when parts provided on an inside of the control panel 6 of the clothes dryer are fixed or changed.

In other words, in a structure of a terminal block 8 of a conventional clothes dryer, a connector of a terminal with each wire was exposed and there was a great chance of accidents caused by touching the high voltage exposed part of core wire 10 by hands while workers fix or change parts.

However, the terminal block 8 includes a wall 800 for shielding the exposed part of core wire in upper and lower front surfaces thereof, the wall having height enough to cover a first connector connecting a lower part of the terminal with a power cord wire 9a and a second connector connecting an upper part with a power cord wire 9a, so as to prevent workers from contacting the expose part of core wire 10 with a body part such as a hand.

Accordingly, the accident caused by contacting the high-voltage wire when workers fix or change internal parts is not generated and operation efficiency is increased according to the present invention.

As aforementioned, the present invention is a structure of the terminal block provided on the inside of the control panel of the clothes dryer is improved for shielding exposed part of core wire of terminal block in the clothes dryer. Therefore, the accident caused by contacting the high-voltage wire when workers fix or change internal parts is not generated and operation efficiency is increased according to the present invention.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A structure for shielding an exposed part of core wire of a terminal block in a clothes dryer comprising:
a base forming a floor;
a front cabinet forming a front of the clothes dryer;
a side cabinet forming a side of the clothes dryer;
a back cover forming a back side of the clothes dryer;
a top cover provided on a top surface of the front cabinet, the side cabinet and the back cover;
a control panel provided on a rear of the top cover;
a terminal block provided on an inside of the control panel; and
a wall for shielding an exposed part of core wire in upper and lower front terminal block.

2. The structure for shielding an exposed part of core wire of a terminal block in a clothes dryer of claim 1, wherein the wall for shielding the exposed part of core wire covers a first connector connecting a lower part of the terminal with a power cord wire 9a and a second connector connecting an upper part with a power cord wire 9a not only from a front side view but also from a side view.

3. The structure for shielding an exposed part of core wire of a terminal block in a clothes dryer of claim 1, wherein the wall for shielding the exposed part of core wire and the terminal block are formed as a single body when forming the terminal block.
